(19) United States
(12) Patent Application Publication
(10) Pub. No.: US 2025/0178346 A1
(43) Pub. Date: Jun. 5, 2025

(54) LIQUID DISCHARGE HEAD, HEAD MODULE, AND LIQUID DISCHARGE APPARATUS

(71) Applicants: Yukimasa MATSUDA, KANAGAWA (JP); Keishi MIWA, KANAGAWA (JP)

(72) Inventors: Yukimasa MATSUDA, KANAGAWA (JP); Keishi MIWA, KANAGAWA (JP)

(21) Appl. No.: 18/954,515

(22) Filed: Nov. 20, 2024

(30) Foreign Application Priority Data
Nov. 30, 2023 (JP) 2023-202986

(51) Int. Cl. B41J 2/14; B41J 3/54

(52) U.S. Cl. CPC B41J 2/14233; B41J 3/543; B41J 2002/14241

(57) ABSTRACT

A liquid discharge head includes a liquid chamber substrate, a pressure generator, a nozzle substrate, a holding substrate, a conductive resin, and a conductive frame. The liquid chamber substrate has a first face, a second face, four corner portions respectively having first edge portions on first side faces of the liquid chamber substrate, and a pressure chamber to accommodate a liquid. The nozzle substrate is bonded to the first face. The holding substrate has a third face bonded to the second face, a fourth face opposite the third face, and second edge portions on second side faces of the holding substrate. The second edge portions are respectively connected to the first edge portions. The conductive resin covers the four corner portions, and the first edge portions and the second edge portions from the first face to the fourth face. The conductive frame is bonded to the fourth face.

### CROSS-REFERENCE TO RELATED APPLICATION

This patent application is based on and claims priority pursuant to 35 U.S.C. § 119 (a) to Japanese Patent Application No. 2023-202986, filed on Nov. 30, 2023, in the Japan Patent Office, the entire disclosure of which is hereby incorporated by reference herein.

### BACKGROUND

### Technical Field

The present disclosure relates to a liquid discharge head, a head module, and a liquid discharge apparatus.

### Related Art

In a piezoelectric system as a discharge system of a typical inkjet head, a head substrate includes a nozzle substrate, a liquid chamber substrate, a damper, and a holding substrate (damper frame) bonded to one on another. The nozzle substrate is a substrate for discharging ink to the outside as ink droplets. The liquid chamber substrate converts electrical energy into mechanical energy such as displacement or force. The damper dissipates the energy to reduce impact. The holding substrate has a space in which the damper is movable.

### SUMMARY

The present disclosure described herein provides an improved liquid discharge head including a liquid chamber substrate, a pressure generator, a nozzle substrate, a holding substrate, a conductive resin, and a conductive frame. The liquid chamber substrate has a first face, a second face opposite the first face, four corner portions respectively having first edge portions on first side faces of the liquid chamber substrate, and a pressure chamber to accommodate a liquid. The pressure generator changes a volume of the pressure chamber. The nozzle substrate is bonded to the first face of the liquid chamber substrate. The holding substrate has a third face bonded to the second face of the liquid chamber substrate, a fourth face opposite the third face, and second edge portions on second side faces of the holding substrate. The second edge portions are respectively connected to the first edge portions of the four corner portions. The conductive resin covers the four corner portions, and the first edge portions and the second edge portions from the first face of the liquid chamber substrate to the fourth face of the holding substrate. The conductive frame is bonded to the fourth face of the holding substrate.

The present disclosure described herein further provides an improved liquid discharge head including a liquid chamber substrate, a pressure generator, a nozzle substrate, a holding substrate, a conductive resin, and a conductive frame. The liquid chamber substrate has a first face, a second face opposite the first face, four corner portions respectively having first edge portions on first side faces of the liquid chamber substrate, and a pressure chamber to accommodate a liquid. The pressure generator changes a volume of the pressure chamber. The nozzle substrate is bonded to the first face of the liquid chamber substrate. The holding substrate has a third face bonded to the second face of the liquid chamber substrate, a fourth face opposite the third face, and second edge portions on second side faces of the holding substrate. The second edge portions are respectively connected to the first edge portions of the four corner portions. The conductive resin covers the four corner portions, the first edge portions and the second edge portions from the first face of the liquid chamber substrate to the fourth face of the holding substrate, and the first side faces. The conductive frame is bonded to the fourth face of the holding substrate.

The present disclosure described herein further provides an improved liquid discharge head including a liquid chamber substrate, a pressure generator, a nozzle substrate, a holding substrate, a conductive resin, and a conductive frame. The liquid chamber substrate has a first face, a second face opposite the first face, first side faces on a periphery of the first face of the liquid chamber substrate, and a pressure chamber to accommodate a liquid. The pressure generator changes a volume of the pressure chamber. The nozzle substrate is bonded to the first face of the liquid chamber substrate. The holding substrate has a third face bonded to the second face of the liquid chamber substrate, a fourth face opposite the third face, and second side faces respectively connected to the first side faces. The conductive resin covers the first side faces and the second side faces. The conductive frame is bonded to the fourth face of the holding substrate.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is an exploded perspective view of a head module as viewed from a nozzle face side thereof;

FIG. 2 is a cross-sectional view of the head module of FIG. 1 in a transverse direction of a liquid discharge head;

FIG. 3 is an enlarged detailed view of a holding substrate and the surroundings thereof in the cross-sectional view of FIG. 2;

FIG. 4A is a cross-sectional side view of a head substrate according to a first embodiment;

FIG. 4B is a plan view of the head substrate of FIG. 4A when viewed from a nozzle substrate side;

FIG. 5A is a cross-sectional side view of a head substrate according to a second embodiment;

FIG. 5B is a plan view of the head substrate of FIG. 5A when viewed from a nozzle substrate side;

FIG. 6A is another cross-sectional side view of a head substrate according to the second embodiment;

FIG. 6B is a plan view of the head substrate of FIG. 6A when viewed from a nozzle substrate side;

FIG. 7A is a cross-sectional side view of the head substrate according to the first embodiment, illustrating a current flow in the head substrate;

FIG. 7B is a cross-sectional side view of a head substrate according to a third embodiment, illustrating a current flow in the head substrate;

FIG. 8A is a schematic exploded perspective view of liquid discharge heads according to a fourth embodiment;

FIG. 8B is a plan view of the liquid discharge heads of FIG. 8A when viewed from a nozzle substrate side;

FIG. 9 is a schematic view of a liquid discharge apparatus;

FIG. 10 is a plan view of a head unit of the liquid discharge apparatus of FIG. 9;

FIG. 11 is another schematic view of a liquid discharge apparatus;

FIG. 12 is a schematic side view of the liquid discharge apparatus of FIG. 11;

FIG. 13 is a schematic view of a liquid discharge unit;

FIG. 14 is another schematic view of a liquid discharge unit;

FIG. 15 is a schematic view of an electrode manufacturing apparatus as a liquid discharge apparatus according to a first applied case;

FIG. 16 is a schematic view of an ultrasonic diagnostic apparatus to which an actuator according to a second applied case is applied;

FIG. 17 is a schematic view of an ultrasonic probe according to the second applied case; and

FIG. 18 is a cross-sectional view of an actuator according to the second applied case.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the attached drawings. In the drawings for illustrating embodiments of the present disclosure, like elements or like components in function or shape are given like reference signs as far as distinguishable, and overlapping descriptions may be omitted.

In a comparative liquid discharge head, when static electricity is generated in, for example, a manufacturing process, a head substrate is charged, and an excessive current (static electricity) flows to the head substrate, so that the electrode of the liquid chamber substrate may be damaged.

In the present embodiment, a liquid discharge head has an inkjet structure in which the outermost circumference of the head substrate is covered with a conductive resin. Due to such a structure, static electricity generated in a nozzle substrate is discharged to the outside through the conductive resin, a conductive frame, and a base.

At least a part of the outermost circumference of the head substrate is covered with the conductive resin to discharge a current generated in the head substrate. Accordingly, the liquid discharge head which is not affected by static electricity can be provided. Thus, the head substrate can be prevented from being damaged by an excessive current (static electricity).

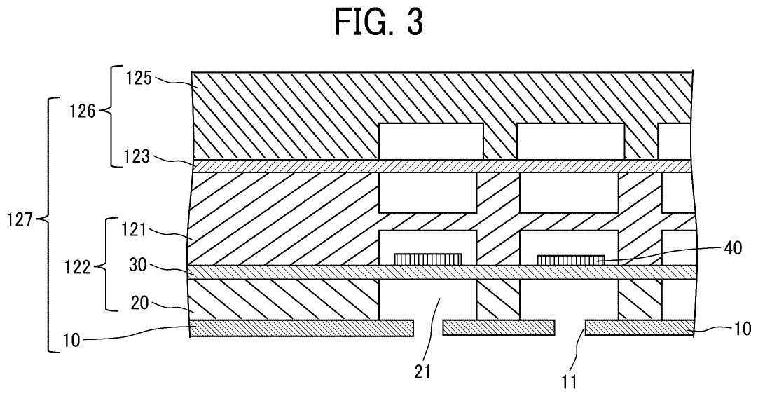

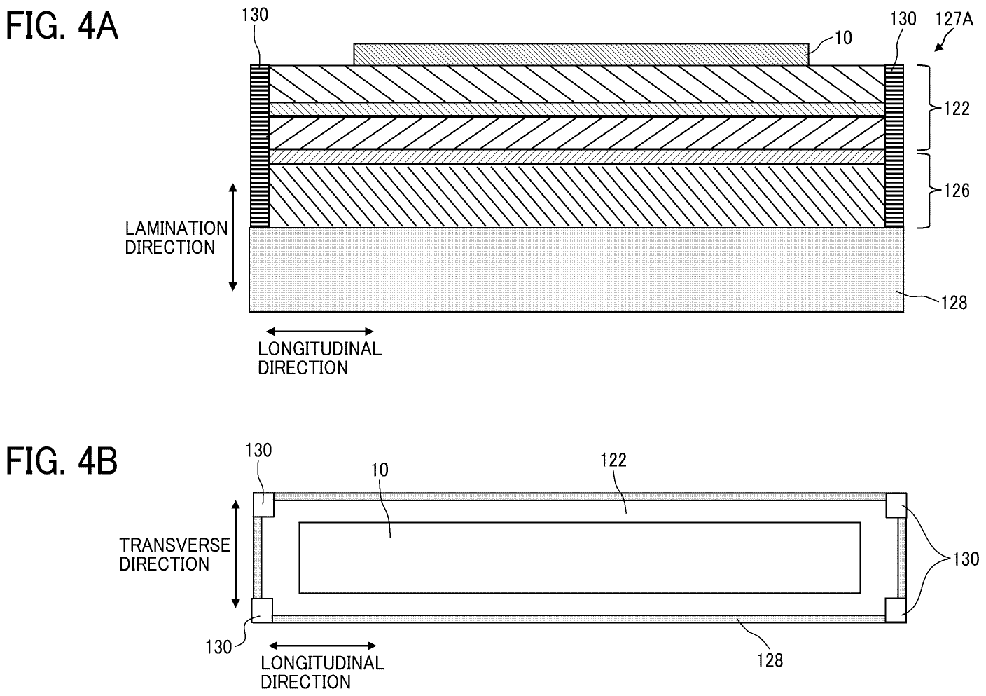

A liquid discharge head includes, for example, a liquid chamber substrate (liquid chamber substrate 122) having a pressure chamber whose volume can be changed by a pressure generator (piezoelectric element 40), a nozzle substrate (nozzle substrate 10) bonded to the liquid chamber substrate, and a holding substrate (holding substrate 126) bonded to the liquid chamber substrate on the side opposite the nozzle substrate. Four corner portions of the liquid chamber substrate and side faces of at least the four corner portions from the liquid chamber substrate to the holding substrate are covered with a conductive resin (conductive resin 130). A conductive frame (conductive frame 128) is bonded to the face of the holding substrate opposite the face bonded to the liquid chamber substrate. The names and reference numerals written in the parentheses correspond to components illustrated in FIGS. 3 and FIGS. 4A and 4B, respectively.

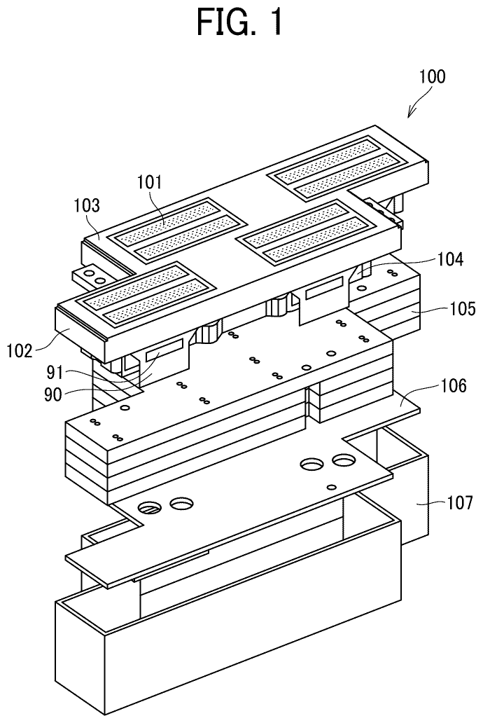

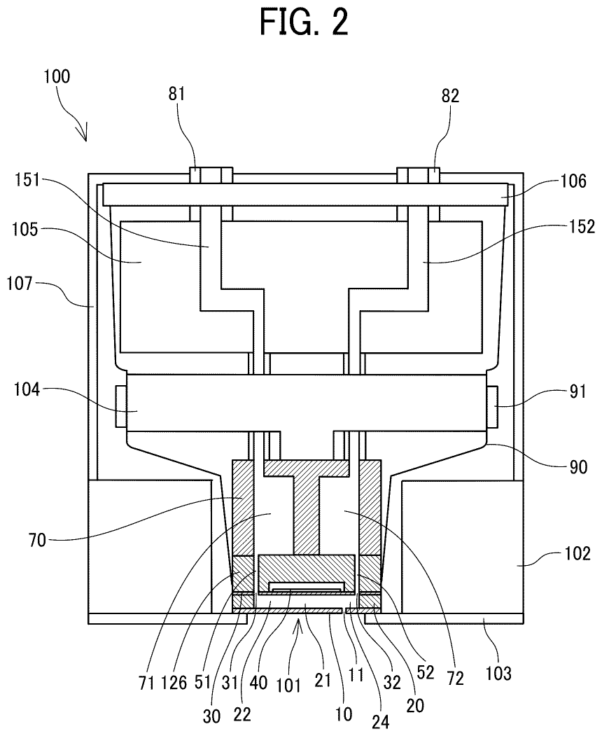

The liquid discharge head is described below with reference to the drawings. FIG. 1 is an exploded perspective view of a head module 100 as viewed from a nozzle face side. FIG. 2 is a cross-sectional view of the head module 100 taken in a head transverse direction. The head module 100 (may be referred to as a “liquid discharge unit” or a “head unit”) will be described below with reference to FIGS. 1 and 2.

The head module 100 includes multiple heads (liquid discharge heads) 101, a base 102, a cover 103 (may be referred to as a “nozzle cover”), a heat radiator 104, a manifold 105, a printed circuit board (PCB) 106, and a module case 107. In the present embodiment, the head module 100 includes the multiple heads 101, the base 102, and the cover 103.

Each of the multiple heads 101 includes a nozzle substrate 10, a channel substrate 20, a diaphragm 30, a holding substrate 126, and a common channel substrate 70 (may be referred to as a “frame”). Nozzles 11 are formed in the nozzle substrate 10. The channel substrate 20 defines, for example, individual liquid chambers 21 communicating with the nozzles 11, respectively. The diaphragm 30 includes piezoelectric elements 40. The holding substrate 126 is laminated over the diaphragm 30. The common channel substrate 70 is laminated over the holding substrate 126. The piezoelectric element 40 is an example of a pressure generator that can change the volume of the individual liquid chamber 21 as a pressure chamber.

In addition to the individual liquid chambers 21, the channel substrate 20 defines supply-side individual channels 22 communicating with the individual liquid chambers 21 and collection-side individual channels 24 communicating with the individual liquid chambers 21, respectively.

The holding substrate 126 defines supply-side intermediate individual channels 51 and collection-side intermediate individual channels 52. The supply-side intermediate individual channels 51 communicate with the supply-side individual channels 22 via openings 31 of the diaphragm 30, respectively. The collection-side intermediate individual channels 52 communicate with the collection-side individual channels 24 via openings 32 of the diaphragm 30, respectively.

The common channel substrate 70 defines a supply-side common channel 71 and a collection-side common channel 72. The supply-side common channel 71 communicates with the supply-side intermediate individual channels 51. The collection-side common channel 72 communicates with the collection-side intermediate individual channels 52.

The supply-side common channel 71 communicates with a supply port 81 via a channel 151 of the manifold 105. The collection-side common channel 72 communicates with a collection port 82 via a channel 152 of the manifold 105.

The PCB 106 and the piezoelectric element 40 of the head 101 are connected to each other via a flexible wiring 90, and a driver integrated circuit (IC) 91 is mounted on the flexible wiring 90.

FIG. 3 is an enlarged detailed view of the holding substrate 126 and the surroundings thereof in the cross-sectional view of FIG. 2. In FIG. 3, multiple substrates, i.e., the nozzle substrate 10, the liquid chamber substrate 122, and the holding substrate 126 laminated in this order, form a head substrate 127. Preferably, the nozzle substrate 10, the liquid chamber substrate 122, and the holding substrate 126 include silicon.

The configuration of the head substrate 127 included in the liquid discharge head 101 will be described below with reference to FIG. 3. The nozzle substrate 10 has nozzles 11 which are holes for discharging ink droplets (may be referred to as “liquid droplets”) to the outside. The nozzle substrate 10 is bonded to the liquid chamber substrate 122.

The liquid chamber substrate 122 has a structure including the diaphragm 30 including the piezoelectric element 40, the channel substrate 20 bonded to the diaphragm 30, and a sub-frame 121. The sub-frame 121 is bonded to the face of the diaphragm 30 opposite the channel substrate 20 and accommodates the piezoelectric element 40.

The holding substrate 126 includes a damper 123 that disperses energy generated when the piezoelectric element 40 is deformed to reduce an impact and a damper frame 125 having a space in which the damper 123 can vibrate. The liquid chamber substrate 122 is bonded to the damper 123. The damper 123 is also bonded to the damper frame 125.

The liquid chamber substrate 122 has a shape having four corner portions on a bonded face (i.e., a first face) to which the nozzle substrate 10 is bonded, but the nozzle substrate 10 is not bonded to the four corner portions. In other words, the four corner portions are exposed. The liquid chamber substrate 122 has side faces (i.e., first side faces), including two longitudinal faces and two transverse faces extending in a lamination direction of these substrates, on a periphery of the bonded face (i.e., the first face) of the liquid chamber substrate 122. The same applies to other substrates such as the holding substrate 126.

The corner portion has an area within a predetermined length from an intersection (vertex) of straight sides of the bonded face of the liquid chamber substrate 122. Within the predetermined length, for example, the substrate may be likely to be damaged. The side faces of the liquid chamber substrate 122 have edge portions (i.e., first edge portions) defined by, for example, a length from edges, which extend in the lamination direction, between the longitudinal faces and the transverse faces. The same applies to other substrates such as the holding substrate 126. In other words, the four corner portions of the liquid chamber substrate 122 have the edge portions (i.e., the first edge portions) on the side faces (i.e., the first side faces), respectively. The edge portions (i.e., second edge portions) on side faces (i.e., second side faces) of the holding substrate 126 are connected to the edge portions of the liquid chamber substrate 122, respectively. The side faces (i.e., the second side faces) of the holding substrate 126 are connected to the side faces (i.e., the first side faces) of the liquid chamber substrate 122, respectively.

A head substrate and a liquid discharge head according to the present embodiment will be described below.

### First Embodiment

FIG. 4A is a cross-sectional side view of a head substrate according to a first embodiment. FIG. 4B is a plan view of the head substrate of FIG. 4A when viewed from a nozzle substrate side.

In a head substrate 127A, the four corner portions of the liquid chamber substrate 122, and the edges portions of the liquid chamber substrate 122 and the holding substrate 126 corresponding to the four corner portions are covered with a conductive resin 130.

A conductive frame 128 is bonded to the face (i.e., a fourth face) of the holding substrate 126 opposite the face (i.e., a third face) bonded to the face (i.e., a second face) of the liquid chamber substrate 122. The conductive frame 128 is an example of the common channel substrate 70. The conductive frame 128 is a metal frame or a sputtered frame, and a portion of the surface of the conductive frame 128 in contact with the base 102 is conductive.

In the head substrate 127A, the four corner portions of the liquid chamber substrate 122, and the edge portions of the liquid chamber substrate 122 and the holding substrate 126 are covered with the conductive resin 130. Such a configuration can reduce chipping, scratches, and cracking due to contact with the outside while preventing electrostatic charging.

The head substrate 127A bonded to the conductive frame 128 discharges static electricity generated on the head substrate 127A through the path from the conductive resin 130 to the conductive frame 128. Thus, the head substrate 127A can be prevented from being electrostatically charged.

With such a configuration, for example, even when the head substrate 127A is made of an electrically insulative material, the generated static electricity can be discharged to prevent the head substrate 127A from being electrostatically charged.

### Second Embodiment

In a second embodiment, at least the side faces of the liquid chamber substrate 122 are covered with the conductive resin 130. In the present embodiment, as in the first embodiment, the conductive frame 128 is bonded to a face of the holding substrate 126 opposite the other face bonded to the liquid chamber substrate 122.

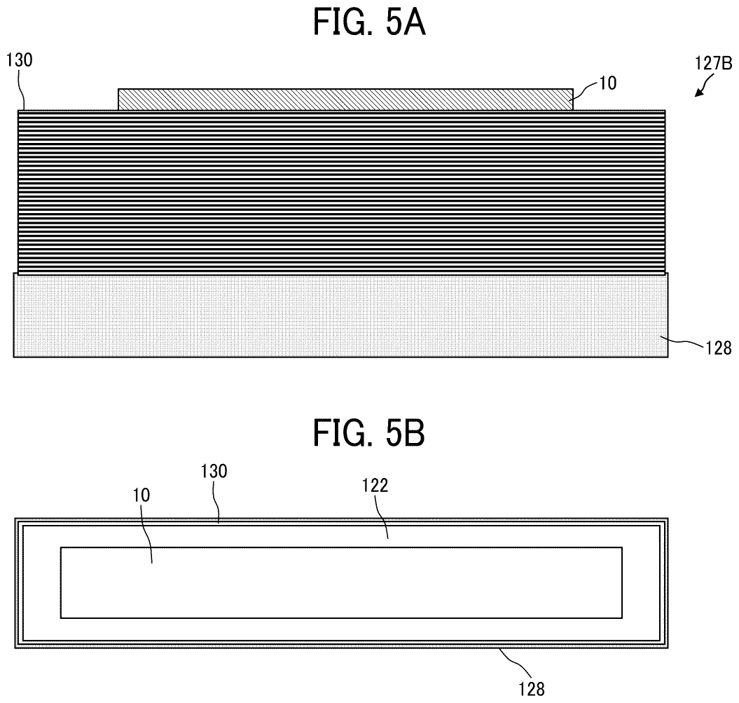

FIG. 5A is a cross-sectional side view of a head substrate according to the second embodiment. FIG. 5B is a plan view of the head substrate of FIG. 5A when viewed from a nozzle substrate side.

In a head substrate 127B, the side faces (i.e., the first side faces) of the liquid chamber substrate 122 and the side faces (i.e., the second side faces) of the holding substrate 126 are covered with the conductive resin 130.

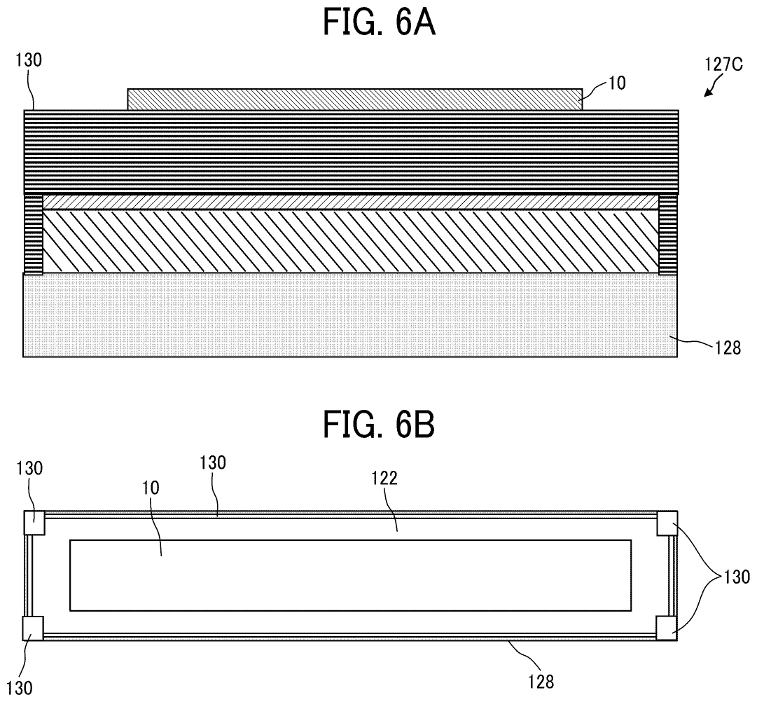

FIG. 6A is another cross-sectional side view of a head substrate according to the second embodiment. FIG. 6B is a plan view of the head substrate of FIG. 6A when viewed from a nozzle substrate side.

In a head substrate 127C, the side faces of the liquid chamber substrate 122 are covered with the conductive resin 130 in addition to the conductive resin 130 included in the head substrate 127A of the first embodiment. In other words, in the head substrate 127C, the four corner portions of the liquid chamber substrate 122, the side faces (including the edge portions) of the liquid chamber substrate 122, and the edge portions of the holding substrate 126 are covered with the conductive resin 130.

The head substrate 127C illustrated in FIG. 6 is an example of a structure in which at least the side faces of the liquid chamber substrate 122 are covered with the conductive resin 130 in the head substrate 127A of the first embodiment, but the structure is not limited thereto. In addition to the structure of the head substrate 127A of the first embodiment, at least the side faces of the liquid chamber substrate 122 are covered with the conductive resin 130.

For example, as in the head substrate 127B of FIG. 5, the side faces of the liquid chamber substrate 122 and the holding substrate 126 may be covered with the conductive resin 130. In this case, the four corner portions of the liquid chamber substrate 122, the side faces (including the edge portions) of the liquid chamber substrate 122, and the side faces (including the edge portions) of the holding substrate 126 are covered with the conductive resin 130. Alternatively, a part of the side faces (excluding the edge portions) of the liquid chamber substrate 122 and the holding substrate 126 may be covered with the conductive resin 130.

In the head substrate 127B or 127C, at least the side faces of the liquid chamber substrate 122 are covered with the conductive resin 130. Such a configuration can reduce chipping, scratches, and cracking due to contact with the outside while preventing electrostatic charging.

Each of the head substrates 127B and 127C bonded to the conductive frame 128 discharges the static electricity generated on each of the head substrates 127B and 127C through the path from the conductive resin 130 to the conductive frame 128. Thus, each of the head substrates 127B and 127C can be prevented from being electrostatically charged.

### Third Embodiment

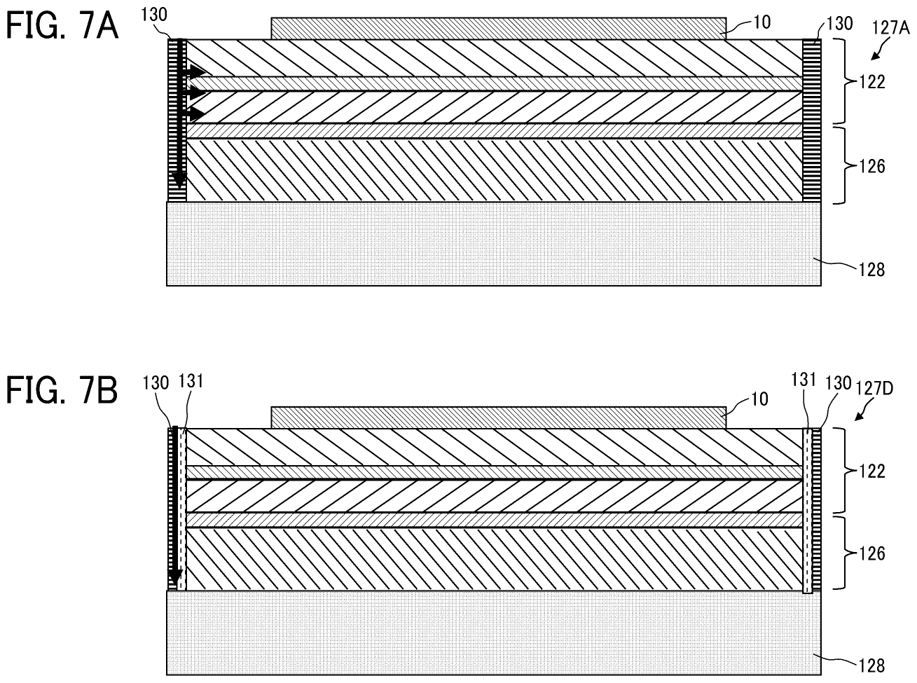

FIG. 7A is a cross-sectional side view of the head substrate according to the first embodiment, illustrating a current flow in the head substrate. FIG. 7B is a cross-sectional side view of a head substrate according to a third embodiment, illustrating a current flow in the head substrate.

As illustrated in FIG. 7A, in the head substrate 127A, the ends of the liquid chamber substrate 122 and the holding substrate 126 are exposed on the side faces. Accordingly, a part of the discharged current may flow into the head substrate 127A. Specifically, the current flowing through the conductive resin 130 may flow into the head substrate 127A.

For this reason, the side faces of the head substrate according to the present embodiment are protected by an insulating resin, and the insulating resin on the head substrate is covered with a conductive resin from above.

In a head substrate 127D illustrated in FIG. 7B, a resin covering the edge portions of the liquid chamber substrate 122 and the holding substrate 126 has a two-layer structure of an insulating resin 131 and the conductive resin 130.

Preferably, metal, which may be included in at least one of the liquid chamber substrate 122 or the holding substrate 126, is not exposed on the side faces of the liquid chamber substrate 122 and the holding substrate 126. In other words, the liquid chamber substrate 122 and the holding substrate 126 include silicon, and the side faces (i.e., the first side faces and the second side faces) of the liquid chamber substrate 122 and the holding substrate 126 are formed of the silicon.

The head substrate 127D is illustrated as an example in which the conductive resin 130 of the head substrate 127A of FIG. 4A are replaced with the two-layer structure of the insulating resin 131 and the conductive resin 130, but the two-layer structure of the insulating resin 131 and the conductive resin 130 may be applied to, for example, the head substrate 127B or 127C of the second embodiment.

As described above, in the present embodiment, the resin covering the side faces of the head substrate (e.g., the head substrate 127A, 127B, 127C, or 127D) has the two-layer structure of the insulating resin 131 and the conductive resin 130. The side faces protected by the insulating resin 131 can prevent a current from flowing into the head substrate.

### Fourth Embodiment

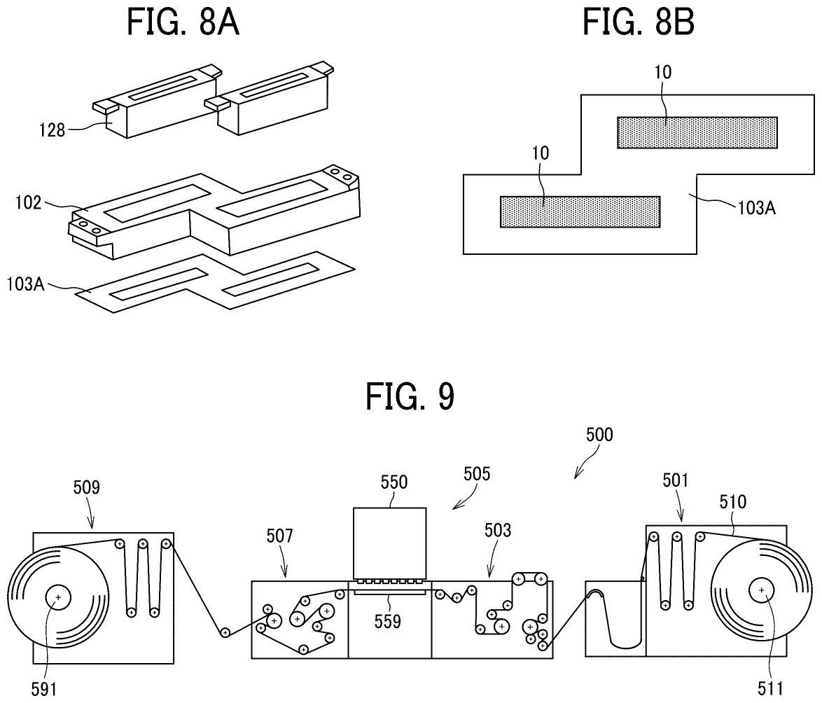

FIG. 8A is a schematic exploded perspective view of liquid discharge heads according to a fourth embodiment. FIG. 8B is a plan view of the liquid discharge heads of FIG. 8A when viewed from a nozzle substrate side. In the liquid discharge heads according to the present embodiment, the conductive frame 128 are directly attached to the base 102 made of metal (i.e., a metal base) without an insulator interposed therebetween. A nozzle cover 103A (i.e., a metal cover) made of metal is bonded to the surface of the base 102 on a nozzle substrate side (i.e., the surface adjacent to the nozzle substrate 10). The nozzle cover 103A is an example of the cover 103 that holds the multiple liquid discharge heads 101 (see FIG. 1). In FIG. 8B, the nozzle substrate 10 is illustrated by hatching.

In the liquid discharge head, the conductive resin 130, the conductive frame 128, the base 102, and the nozzle cover 103A are bonded to each other without an insulator interposed therebetween, and thus the static electricity generated on the head substrate is discharged to the outside. With such a configuration, since the base and the cover are made of metal, even if the static electricity is generated in the head substrate, the static electricity is discharged.

### Liquid Discharge Unit and Liquid Discharge Apparatus

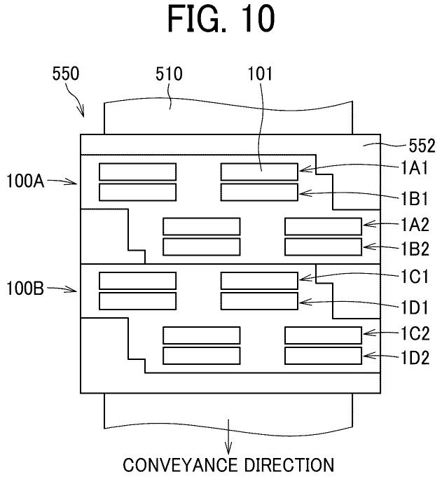

A liquid discharge apparatus according to an embodiment of the present disclosure is described below with reference to FIGS. 9 and 10. FIG. 9 is a schematic view of the liquid discharge apparatus. FIG. 10 is a plan view of a head unit of the liquid discharge apparatus in FIG. 9.

A printer 500 as the liquid discharge apparatus includes a feeder 501 to feed a continuous medium 510, a guide conveyor 503 (i.e., a conveyor) to guide and convey the continuous medium 510, fed from the feeder 501, to a printing device 505, the printing device 505 to discharge a liquid onto the continuous medium 510 to form an image on the continuous medium 510, a dryer 507 to dry the continuous medium 510, and a carrier 509 to feeds the dried continuous medium 510 outward.

The continuous medium 510 (i.e., a medium) is fed from a winding roller 511 of the feeder 501, guided and conveyed with rollers of the feeder 501, the guide conveyor 503, the dryer 507, and the carrier 509, and wound around a take-up roller 591 of the carrier 509.

In the printing device 505, the continuous medium 510 is conveyed on a conveyance guide 559 so as to face a head unit 550. The head unit 550 discharges a liquid onto the continuous medium 510 to form an image.

As illustrated in FIG. 10, the head unit 550 includes two head modules 100A and 100B on a common base 552. The head module 100A includes head arrays 1A1, 1B1, 1A2, and 1B2. Each of the head arrays 1A1, 1B1, 1A2, and 1B2 includes multiple liquid discharge heads 101 arranged in a head array direction perpendicular to a conveyance direction of the continuous medium 510. The head module 100B includes head arrays 1C1, 1D1, 1C2, and 1D2. Each of the head arrays 1C1, 1D1, 1C2, and 1D2 includes multiple liquid discharge heads 101 arranged in the head array direction. The head arrays 1A1 and 1A2 of the head module 100A discharge a liquid of the same color. Similarly, the head arrays 1B1 and 1B2 of the head module 100A are grouped as one set and discharge a liquid of the same desired color. The head arrays 1C1 and 1C2 of the head module 100B are grouped as one set and discharge a liquid of the same desired color. The head arrays 1D1 and 1D2 of the head module 100B are grouped as one set and discharge a liquid of the same desired color.

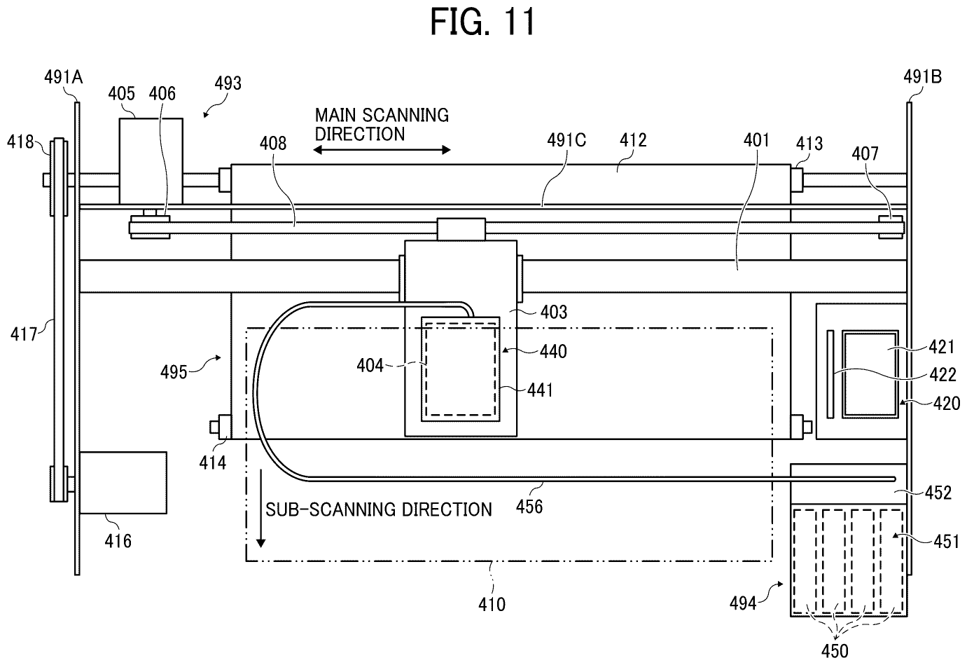

Another liquid discharge apparatus according to the present embodiment will be described below with reference to FIGS. 11 and 12. FIG. 11 is a plan view of a part of the liquid discharge apparatus. FIG. 12 is a side view of the part of the liquid discharge apparatus.

The liquid discharge apparatus is a serial-type apparatus in which a main-scanning moving mechanism 493 reciprocates a carriage 403 in a main scanning direction. The main-scanning moving mechanism 493 includes, for example, a guide 401, a main-scanning motor 405, and a timing belt 408. The guide 401 is bridged between left and right side plates 491A and 491B to movably hold the carriage 403. The main-scanning motor 405 reciprocates the carriage 403 in the main scanning direction via the timing belt 408 looped around a drive pulley 406 and a driven pulley 407.

The carriage 403 includes a liquid discharge unit 440 in which a liquid discharge head 404 and a head tank 441 are integrated into a single unit. The liquid discharge head 404 of the liquid discharge unit 440 discharges color liquids of, for example, yellow (Y), cyan (C), magenta (M), and black (K). The liquid discharge head 404 is mounted on the liquid discharge unit 440 of the carriage 403 such that a row of the multiple nozzles 11 is arrayed in the sub-scanning direction perpendicular to the main scanning direction. The liquid discharge head 404 discharges the color liquid downward. For example, the above-described liquid discharge head 101 can be used as the liquid discharge head 404.

A supply mechanism 494 disposed outside the liquid discharge head 404 supplies liquid stored in liquid cartridges 450 to the head tank 441 to supply the liquid to the liquid discharge head 404. The supply mechanism 494 includes a cartridge holder 451 which is a filling part to mount the liquid cartridges 450, a tube 456, and a liquid feed unit 452 including a liquid feed pump. The liquid cartridge 450 is detachably mounted on the cartridge holder 451. The liquid feed unit 452 feeds the liquid from the liquid cartridge 450 to the head tank 441 via the tube 456.

The liquid discharge apparatus further includes a conveyance mechanism 495 to convey a sheet 410. The conveyance mechanism 495 includes a conveyance belt 412 (i.e., a conveyor) and a sub-scanning motor 416 to drive the conveyance belt 412. The conveyance belt 412 attracts the sheet 410 and conveys the sheet 410 to a position facing the liquid discharge head 404. The conveyance belt 412 is an endless belt looped around a conveyance roller 413 and a tension roller 414. The sheet 410 can be attracted to the conveyance belt 412 by, for example, electrostatic attraction or air suction. The conveyance belt 412 circumferentially moves in the sub-scanning direction as the conveyance roller 413 is rotationally driven by the sub-scanning motor 416 via a timing belt 417 and a timing pulley 418.

On one end of the range of movement of the carriage 403 in the main scanning direction, a maintenance mechanism 420 that maintains and recovers the liquid discharge head 404 is disposed lateral to the conveyance belt 412. The maintenance mechanism 420 includes, for example, a cap 421 to cap the nozzle face (i.e., the surface on which the nozzles 11 are formed) of the liquid discharge head 404 and a wiper 422 to wipe the nozzle face.

The main-scanning moving mechanism 493, the supply mechanism 494, the maintenance mechanism 420, and the conveyance mechanism 495 are mounted onto a housing including the side plates 491A and 491B and a back plate 491C.

In the liquid discharge apparatus having the above-described configuration, the sheet 410 is fed and attracted onto the conveyance belt 412 and conveyed in the sub-scanning direction as the conveyance belt 412 circumferentially moves. The liquid discharge head 404 is driven in response to an image signal while the carriage 403 moves in the main scanning direction to discharge liquid onto the sheet 410 not in motion. As a result, an image is formed on the sheet 410.

As described above, the liquid discharge apparatus includes the liquid discharge head according to an embodiment of the present disclosure, thus allowing the stable formation of high-quality images.

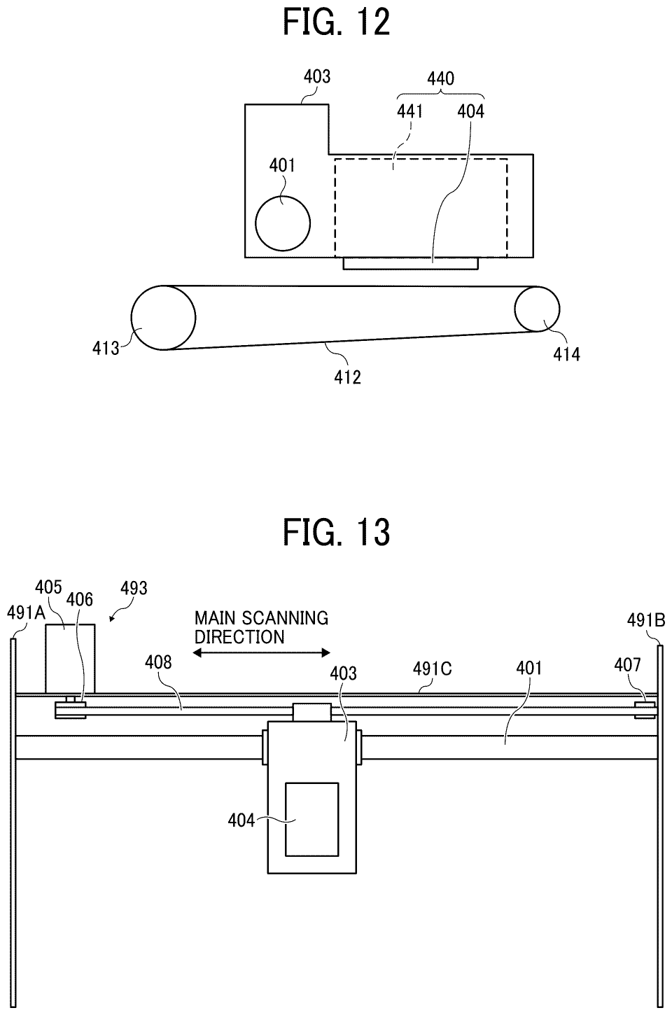

A liquid discharge unit according to an embodiment of the present disclosure is described below with reference to FIG. 13. FIG. 13 is a plan view of a part of the liquid discharge unit. The liquid discharge unit includes the housing, the main-scanning moving mechanism 493, the carriage 403, and the liquid discharge head 404 among the components of the liquid discharge apparatus described above. The side plates 491A and 491B, and the back plate 491C construct the housing. The liquid discharge unit may further include at least one of the maintenance mechanism 420 or the supply mechanism 494, which may be attached to the side plate 491B.

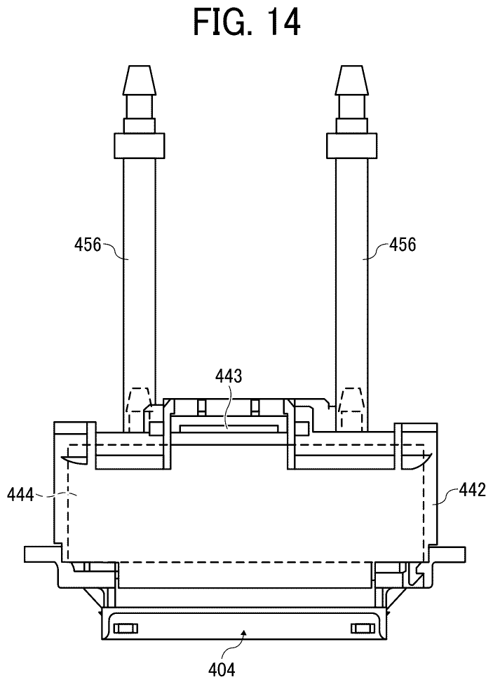

Another liquid discharge unit according to an embodiment of the present disclosure is described below with reference to FIG. 14. FIG. 14 is a front view of the liquid discharge unit. The liquid discharge unit includes the liquid discharge head 404 to which a channel component 444 is attached, and tubes 456 connected to the channel component 444. The channel component 444 is disposed inside a cover 442. Alternatively, the liquid discharge unit 440 may include the head tank 441 instead of the channel component 444. A connector 443 for electrically connecting to the liquid discharge head 404 is disposed on an upper portion of the channel component 444.

Applied cases of the liquid discharge head or the liquid discharge apparatus according to the above-described embodiments will be described below.

### First Applied Case: Electrode Manufacturing Apparatus

The liquid discharge apparatus according to an embodiment of the present disclosure may also include an apparatus for manufacturing an electrode and an electrochemical element that is also referred to as an electrode manufacturing apparatus. An electrode manufacturing apparatus is described below.

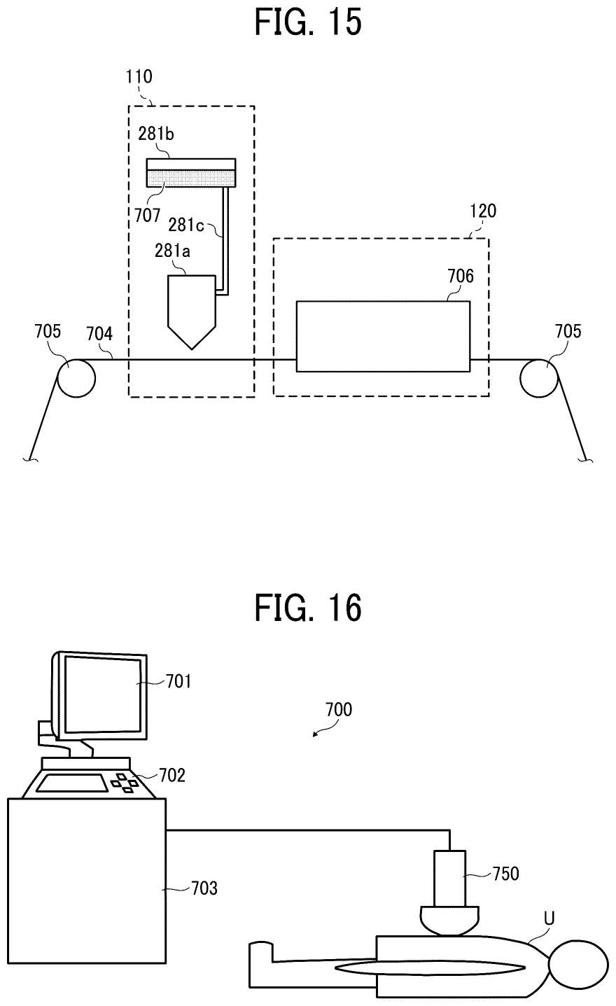

FIG. 15 is a schematic view of an electrode manufacturing apparatus as a liquid discharge apparatus according to a first applied case. The electrode manufacturing apparatus is an apparatus for manufacturing an electrode including a layer containing an electrode material by discharging a liquid composition using a head module including a liquid discharge head.

### Device for Forming Layer Containing Electrode Material and Process of Forming Layer Containing Electrode Material

A discharge device in the electrode manufacturing apparatus illustrated in FIG. 15 is the head module according to the above-described embodiments of the present disclosure. The liquid discharge head of the head module discharges a liquid composition. By so doing, the liquid composition is applied onto an object, and a liquid composition layer is formed on the object. The object, which may also be referred to as a discharge target in the following description, is not particularly limited and may be appropriately selected depending on the intended purpose, as long as the object is an object on which a layer containing an electrode material is to be formed. Examples of the object include an electrode substrate, i.e., a current collector, an active material layer, and a layer containing a solid electrode material. The object may be an electrode composite layer containing an active material on an electrode substrate, i.e., a current collector. The discharge device and a discharge process may be a device and a process of forming a layer containing an electrode material by directly discharging a liquid composition as long as the layer containing an electrode material can be formed on a discharge target. The discharge device and the discharge process may be a device and a process of forming a layer containing an electrode material by indirectly discharging a liquid composition.

### Other Devices and Other Processes

Other configurations included in the electrode manufacturing apparatus for manufacturing an electrode composite layer are not particularly limited and may be appropriately selected depending on the intended purpose, as long as the effects of the present embodiment are not impaired. Other processes included in the method for manufacturing an electrode composite layer are not particularly limited and may be appropriately selected depending on the intended purpose, as long as the effects of the present embodiment are not impaired. For example, a heating device and a heating process are examples of the configuration and the process included in the electrode manufacturing apparatus and the manufacturing method of the electrode composite layer.

### Heating Device and Heating Process

The heating device included the electrode manufacturing apparatus for manufacturing an electrode composite layer is a device that heats the liquid composition discharged by the discharge device. The heating process included in the manufacturing method for manufacturing an electrode composite layer is a process of heating the liquid composition discharged in the discharge process. The liquid composition is heated to dry the liquid composition layer.

### Structure to Form Layer Containing Electrode Material by Direct Discharge of Liquid Composition

As an example of the electrode manufacturing apparatus, an electrode manufacturing apparatus that forms an electrode composite layer containing an active material on an electrode substrate, i.e., a current collector, is described below. As illustrated in FIG. 15, the electrode manufacturing apparatus includes a discharge process device 110 and a heating process device 120. The discharge process device 110 performs a discharge process of applying a liquid composition onto a print base material 704 having a discharge target to form a liquid composition layer. The heating process device 120 performs a heating process of heating the liquid composition layer to obtain an electrode composite layer.

The electrode manufacturing apparatus includes a conveyor 705 that conveys the print base material 704. The conveyor 705 conveys the print base material 704 to the discharge process device 110 and the heating process device 120 in this order at a preset speed. A method of producing the print base material 704 having the discharge target such as an active material layer is not limited to any particular method, and a known method can be appropriately selected. The discharge process device 110 includes a liquid discharge head 281a that performs an application process of applying the liquid composition onto the print base material 704, a storage container 281b that stores a liquid composition 707, and a supply tube 281c that supplies the liquid composition 707 stored in the storage container 281b to the liquid discharge head 281a.

The discharge process device 110 discharges the liquid composition 707 from the liquid discharge head 281a so that the liquid composition 707 is applied onto the print base material 704 to form a liquid composition layer in a thin film shape. The storage container 281b may be integrated with the electrode manufacturing apparatus that forms the electrode composite layer or may be detachable from the electrode manufacturing apparatus. The storage container 281b may be a container additionally attachable to a container integrated with the electrode manufacturing apparatus for manufacturing the electrode composite layer or to a container detachable from the electrode manufacturing apparatus for manufacturing the electrode composite layer. The storage container 281b that stably stores the liquid composition 707 and the supply tube 281c that stably supplies the liquid composition 707 can be used.

The heating process device 120 performs a solvent removal process of heating and removing the solvent remaining in the liquid composition layer. Specifically, the solvent that remains in the liquid composition layer is heated and dried by a heater 706 of the heating process device 120. Accordingly, the solvent is removed from the liquid composition layer. Thus, the electrode composite layer is formed. The heating process device 120 may perform the solvent removing process under reduced pressure.

The heater 706 is not particularly limited and may be appropriately selected depending on the intended purpose. For example, the heater 706 may be a substrate heater, an infrared (IR) heater, or a hot air heater. The heater 706 may be a combination of at least two of the substrate heater, the IR heater, and the hot air heater. A heating temperature and heating time can be appropriately selected according to a boiling point of the solvent contained in the liquid composition 707 or the thickness of a formed film.

The electrode manufacturing apparatus according to the present embodiment is used to discharge the liquid composition to a desired position on the discharge target. The electrode composite layer can be suitably used, for example, as a part of the configuration of an electrochemical element. The configuration of the electrochemical element other than the electrode composite layer is not particularly limited, and a known configuration can be appropriately selected. Examples of the configuration other than the electrode composite layer include a positive electrode, a negative electrode, and a separator.

### Second Applied Case: Ultrasonic Diagnostic Apparatus

An ultrasonic diagnostic apparatus, to which a liquid discharge head including a diaphragm member (e.g., the diaphragm 30) is applied, will be described below. The ultrasonic diagnostic apparatus employs the diaphragm member of the liquid discharge head according to the above-described embodiment as an ultrasonic transmitter. In the second applied case, the liquid discharge head does not discharge liquid. In the second applied case, the liquid discharge head according to the above-described embodiment is used as an actuator.

The actuator according to the second applied case is not limited to a device that discharges liquid, and, for example, may be used for emitting ultrasonic waves. The ultrasonic diagnostic apparatus to which the actuator according to the second applied case is applied is described below.

FIG. 16 is a schematic view of the ultrasonic diagnostic apparatus to which the actuator according to the second applied case is applied. An ultrasonic diagnostic apparatus 700 includes an ultrasonic probe 750. The ultrasonic probe 750 emits ultrasonic waves toward a measurement target U and detects vibration of the ultrasonic waves reflected by the measurement target U. The ultrasonic diagnostic apparatus 700 also includes a display 701 that visualizes and displays a signal from the ultrasonic probe 750, a control panel 702, and a controller 703 that controls the ultrasonic probe 750.

Typically, the controller 703 includes an ultrasonic pulse generator, a converter, and an ultrasonic image forming unit. The ultrasonic pulse generator generates a pulsed electrical signal for generating an ultrasonic signal. The converter converts an echo signal received from the ultrasonic probe 750 into an electrical signal. The ultrasonic image forming unit generates a two-dimensional or three-dimensional ultrasonic image, or various Doppler images from echo signals.

The display 701 is, for example, a liquid crystal display (LCD) or a monitoring device and displays an image generated by the controller 703. The control panel 702 is an input device for an operator to input, for example, parameters so as to appropriately diagnose the measurement target U. The control panel 702 may include, for example, a push button and a touch panel.

The ultrasonic probe 750 is electrically connected to the controller 703 via, for example, a cable. The ultrasonic probe 750 emits the ultrasonic signal toward the measurement target U which is a human body or an object and receives the ultrasonic signal reflected as an echo from the measurement target U. Thus, the ultrasonic diagnostic apparatus 700 can visualize an inside of the measurement target U and diagnosis the inside by emitting and receiving an ultrasonic signal.

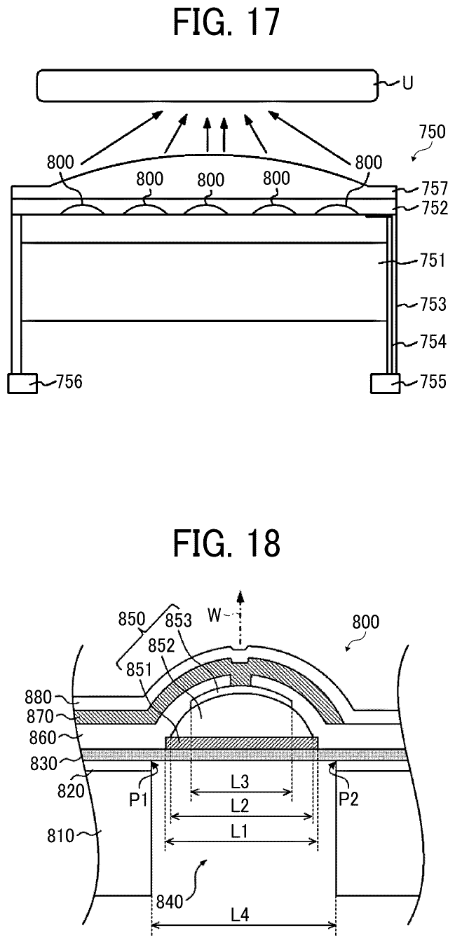

FIG. 17 is a schematic diagram illustrating a configuration of the ultrasonic probe 750 of the ultrasonic diagnostic apparatus 700 illustrated in FIG. 16. The ultrasonic probe 750 includes a support board 751, a piezoelectric micro-machined ultrasonic transducer (PMUT) chip 752 which is an ultrasonic transducer disposed on the support board 751, a flexible printed board 753, wiring 754, connectors 755 and 756, and an acoustic lens 757. The PMUT chip 752 is electrically connected to the connectors 755 and 756 via the flexible printed board 753 and the wiring 754, and the connectors 755 and 756 are connected to the controller 703 via a circuit board. The support board 751 functions as a backing plate to support the PMUT chip 752.

The acoustic lens 757 is made of silicon resin and used for focusing the ultrasonic waves emitted from the PMUT chip 752 on the measurement position of the measurement target U. The acoustic lens 757 has a so-called dome shape in which the central portion is thicker than the peripheral portion. The acoustic lens 757 tightly contacts the measurement target U and deflects the ultrasonic waves in a pseudo manner due to the difference in thickness between the central portion and the peripheral portion to focus the ultrasonic waves. The acoustic lens 757 has a function of focusing ultrasonic waves in at least one direction and does not necessarily focus the ultrasonic waves to one point. The acoustic lens 757 and the PMUT chip 752 are bonded to each other by, for example, an adhesive. The PMUT chip 752 includes the array of multiple actuators 800. The actuator 800 is described below in detail.

FIG. 18 is a cross-sectional view of the actuator 800 in the ultrasonic probe 750 illustrated in FIG. 17. The actuator 800 includes a silicon substrate 810, a wiring 820, a vibration film 830, a piezoelectric element 850, an insulating film 860, a lead 870, and a protective film (moisture-proof film) 880. A void space 840, which is an opening having, for example, a cylindrical shape, is formed in the silicon substrate 810, and the wiring 820 is laminated over the silicon substrate 810.

The wiring 820 is formed over the silicon substrate 810 and includes a wiring for applying a voltage to a first electrode 851 and a wiring for applying a voltage to a second electrode 853. The vibration film 830 as the diaphragm member is laminated over the wiring 820.

The vibration film 830 is formed over the wiring 820. As the vibration film 830 receives vibrations from the piezoelectric element 850, the vibration film 830 is displaced in the vertical direction in FIG. 18. The piezoelectric element 850 over the vibration film 830 includes the first electrode 851, a piezoelectric body 852, and the second electrode 853. The first electrode 851 may be referred to as a lower electrode, and the second electrode 853 may be referred to as an upper electrode.

The first electrode 851 has a width L1 (outer diameter) which is smaller than a width L4 (inner diameter) of the void space 840 formed in the silicon substrate 810, and has an outer shape that fits inside the void space 840. The second electrode 853 is formed along a dome-shaped upper face of the piezoelectric body 852.

A width L3 (outer diameter) of the second electrode 853 is preferably smaller than a width L2 (outer diameter) of the piezoelectric body 852. In particular, when the piezoelectric body 852 has a dome shape, the width L3 of the second electrode 853 is smaller than the outer shape of the piezoelectric body 852. As a result, a short circuit between the second electrode 853 and the first electrode 851 can be prevented.

The insulating film 860 prevents a short circuit between the first electrode 851 and the second electrode 853 and a short circuit between the lead 870 and the first electrode 851. In the present embodiment, the piezoelectric body 852 has, but is not limited to, the dome shape. The shape of the piezoelectric body 852 may be a shape other than the dome shape, such as a cylindrical shape.

With the above-described configuration, the piezoelectric body 852 is mechanically deformed by application of a drive voltage between the first electrode 851 and the second electrode 853. By causing periodic fluctuations in the drive voltage, a vibration of a predetermined frequency can be generated. As a result, the vibration film 830 is vibrated to generate ultrasonic waves W.

Further, as ultrasonic waves vibrate the piezoelectric body 852, the piezoelectric body 852 is polarized to generate a potential difference between the first electrode 851 and the second electrode 853. Thus, the actuator 800 also functions as a detector to detect the vibrations as an electrical signal. As described above, the actuator 800 functions as an electromechanical transducer element that periodically expands and contracts the piezoelectric body 852 by a potential difference, which is an electrical signal, between the first electrode 851 and the second electrode 853, to generate vibrations. In particular, in the present embodiment, the actuator 800 functions as an ultrasonic transducer that generates a sound wave in an ultrasonic range with vibrations.

In the actuator 800 having the above-described configuration, portions of the vibration film 830 near the fixed ends P1 and P2 are easily movable since the first electrode 851 has an outer shape that fits inside the void space 840. As a result, the vibration film 830 can be sufficiently vibrated. The deformation efficiency of the vibration film 830 with respect to voltage increases, and the responsiveness to high frequency is not reduced.

In the above-described embodiments, the “liquid discharge apparatus” includes the liquid discharge head or the liquid discharge unit and drives the liquid discharge head to discharge liquid. The liquid discharge apparatus may be, for example, any apparatus that can discharge liquid to a medium onto which liquid can adhere or any apparatus to discharge liquid toward gas or into a different liquid.

The “liquid discharge apparatus” may further include devices relating to feeding, conveying, and ejecting of the medium onto which liquid can adhere and also include, for example, a pretreatment device and an aftertreatment device. The “liquid discharge apparatus” may be, for example, an image forming apparatus to form an image on a sheet by discharging ink, or a three-dimensional fabrication apparatus to discharge fabrication liquid to a powder layer in which powder material is formed in layers, so as to form a three-dimensional object.

The “liquid discharge apparatus” is not limited to an apparatus that discharges liquid to visualize meaningful images such as letters or figures. For example, the liquid discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials of the “medium onto which liquid can adhere” include any materials to which liquid can adhere even temporarily, such as paper, thread, fiber, fabric, leather, metal, plastic, glass, wood, ceramic, construction materials such as wall paper or floor material, cloth textile, a current collector such as an aluminum foil or a copper foil, and an electrode in which an active material layer is formed on the current collector.

Further, the term “liquid” is not limited to a particular liquid and includes any liquid having a viscosity or a surface tension that can be discharged from the head. However, preferably, the viscosity of the liquid is not greater than 30 millipascal-second (mPa·s) under ordinary temperature and ordinary pressure or by heating or cooling. Examples of the liquid include a solution, a suspension, or an emulsion that contains, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; an edible material, such as a natural colorant; an active material and a solid electrolyte used as an electrode material; or ink containing a conductive material or an insulating material. Such a solution, a suspension, or an emulsion can be used for, e.g., inkjet ink, surface treatment solution, a liquid for forming components of electronic element or light-emitting element or a resist pattern of electronic circuit, a material solution for three-dimensional fabrication, an electrode, or an electrochemical element.

Examples of the liquid include ink, treatment liquid, DNA sample, resist, pattern material, binder, fabrication liquid, and solution or liquid dispersion containing amino acid, protein, or calcium.

The liquid discharge apparatus may be an apparatus to move the liquid discharge head and the medium onto which liquid can adhere relative to each other. However, the liquid discharge apparatus is not limited to such an apparatus. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particles of the raw material.

The “liquid discharge apparatus” is not limited to a stationary apparatus. The liquid discharge apparatus may be, for example, a robot which is equipped with a liquid discharge head and movable by remote control or autonomous driving. The movable robot can paint an outer wall of a building and paint a road marking (e.g., a crosswalk, a stop line, and a speed limit) on a road. In this case, a building and a road are also included in the “medium onto which liquid can adhere.”

The “liquid discharge unit” refers to a liquid discharge head integrated with functional components or mechanisms, i.e., an assembly of components related to liquid discharge. For example, the “liquid discharge unit” includes a combination of the liquid discharge head with at least one of a head tank, a carriage, a supply mechanism, a maintenance mechanism, or a main-scanning moving mechanism.

The above integration may be achieved by, for example, a combination in which the liquid discharge head and a functional component(s) or mechanism(s) are fixed to each other through, e.g., fastening, bonding, or engaging, and a combination in which one of the liquid discharge head and the functional component(s) or mechanism(s) is movably held to the other. The liquid discharge head and the functional component(s) or mechanism(s) may be detachably attached to each other.

Examples of the liquid discharge unit include the liquid discharge unit 440 in which a liquid discharge head and a head tank are integrated to form a single unit, as illustrated in FIG. 12. Alternatively, the liquid discharge head and the head tank coupled (connected) to each other via, for example, a tube may form the liquid discharge unit as a single unit. A unit including a filter may further be added to a portion between the head tank and the liquid discharge head of the liquid discharge unit.

In another example, the liquid discharge unit may be an integrated unit in which a liquid discharge head is integrated with a carriage.

As yet another example, the liquid discharge unit is a unit in which the liquid discharge head and the main-scanning moving mechanism are combined into a single unit. The liquid discharge head is movably held by a guide that is a part of the main-scanning moving mechanism. Like the liquid discharge unit 440 illustrated in FIG. 13, the liquid discharge head, the carriage, and the main-scanning moving mechanism may form the liquid discharge unit as a single unit.

In another example, the cap that forms a part of the maintenance mechanism is fixed to the carriage mounting the liquid discharge head so that the liquid discharge head, the carriage, and the maintenance mechanism are integrated as a single unit to form the liquid discharge unit.

Further, in still another example, the liquid discharge unit includes tubes connected to the liquid discharge head to which the head tank or the channel component is attached so that the liquid discharge head and the supply mechanism are integrated as a single unit, as illustrated in FIG. 14.

The main-scanning moving mechanism may be a guide only. The supply mechanism may be a tube(s) only or a loading device only.

The pressure generator used in the liquid discharge head is not limited to a particular type of pressure generator. The pressure generator is not limited to the piezoelectric actuator (or a laminated-type piezoelectric element) described in the above-described embodiments, and may be, for example, a thermal actuator that employs a thermoelectric transducer element, such as a thermal resistor, or an electrostatic actuator including a diaphragm and opposed electrodes.

In the present specification, the terms “image formation,” “recording,” “printing,” “image printing,” and “fabricating” used herein may be used synonymously with each other.

Aspects of the present disclosure are, for example, as follows.

### Aspect 1

A liquid discharge head includes a liquid chamber substrate, a nozzle substrate, and a holding substrate. The liquid chamber substrate forms a pressure chamber whose volume can be changed by a pressure generator. The nozzle substrate is joined to the liquid chamber substrate. The holding substrate is joined to a face of the liquid chamber substrate opposite the other face joined to the nozzle substrate. Four corner portions of the liquid chamber substrate and side faces of at least the four corner portions from the liquid chamber substrate to the holding substrate are covered with a conductive resin. A conductive frame is joined to a face of the holding substrate opposite the other face joined to the liquid chamber substrate.

In other words, a liquid discharge head includes a liquid chamber substrate, a pressure generator, a nozzle substrate, a holding substrate, a conductive resin, and a conductive frame. The liquid chamber substrate has a first face, a second face opposite the first face, four corner portions respectively having first edge portions on first side faces of the liquid chamber substrate, and a pressure chamber to accommodate a liquid. The pressure generator changes a volume of the pressure chamber. The nozzle substrate is bonded to the first face of the liquid chamber substrate. The holding substrate has a third face bonded to the second face of the liquid chamber substrate, a fourth face opposite the third face, and second edge portions on second side faces of the holding substrate. The second edge portions are respectively connected to the first edge portions of the four corner portions. The conductive resin covers the four corner portions, and the first edge portions and the second edge portions from the first face of the liquid chamber substrate to the fourth face of the holding substrate. The conductive frame is bonded to the fourth face of the holding substrate.

### Aspect 2

A liquid discharge head includes a liquid chamber substrate, a nozzle substrate, and a holding substrate. The liquid chamber substrate forms a pressure chamber whose volume can be changed by a pressure generator. The nozzle substrate is joined to the liquid chamber substrate. The holding substrate is joined to a face of the liquid chamber substrate opposite the other face joined to the nozzle substrate. Four corner portions of the liquid chamber substrate, side faces of at least the four corner portions from the liquid chamber substrate to the holding substrate, and at least surfaces of side faces of a periphery of the liquid chamber substrate are covered with a conductive resin. A conductive frame is joined to a face of the holding substrate opposite the other face joined to the liquid chamber substrate.

In other words, a liquid discharge head includes a liquid chamber substrate, a pressure generator, a nozzle substrate, a holding substrate, a conductive resin, and a conductive frame. The liquid chamber substrate has a first face, a second face opposite the first face, four corner portions respectively having first edge portions on first side faces of the liquid chamber substrate, and a pressure chamber to accommodate a liquid. The pressure generator changes a volume of the pressure chamber. The nozzle substrate is bonded to the first face of the liquid chamber substrate. The holding substrate has a third face bonded to the second face of the liquid chamber substrate, a fourth face opposite the third face, and second edge portions on second side faces of the holding substrate. The second edge portions are respectively connected to the first edge portions of the four corner portions. The conductive resin covers the four corner portions, the first edge portions and the second edge portions from the first face of the liquid chamber substrate to the fourth face of the holding substrate, and the first side faces. The conductive frame is bonded to the fourth face of the holding substrate.

### Aspect 3

In the liquid discharge head according to Aspect 1 or 2, a two layer structure of an insulating resin and the conductive resin is formed on the side faces from the liquid chamber substrate to the holding substrate. The insulating resin is disposed between the side faces and the conductive resin.

In other words, the liquid discharge head according to Aspect 1, further includes an insulating resin between the conductive resin and the first edge portions and between the conductive resin and the second edge portions.

Alternatively, the liquid discharge head according to Aspect 2, further includes an insulating resin between the conductive resin and the first side faces and between the conductive resin and the second edge portions.

### Aspect 4

A liquid discharge head includes a liquid chamber substrate, a nozzle substrate, and a holding substrate. The liquid chamber substrate forms a pressure chamber whose volume can be changed by a pressure generator. The nozzle substrate is joined to the liquid chamber substrate. The holding substrate is joined to a face of the liquid chamber substrate opposite the other face joined to the nozzle substrate. Side faces of a periphery of the liquid chamber substrate and the holding substrate are covered with a conductive resin. A conductive frame is joined to a face of the holding substrate opposite the other face joined to the liquid chamber substrate.

In other words, a liquid discharge head includes a liquid chamber substrate, a pressure generator, a nozzle substrate, a holding substrate, a conductive resin, and a conductive frame. The liquid chamber substrate has a first face, a second face opposite the first face, first side faces on a periphery of the first face of the liquid chamber substrate, and a pressure chamber to accommodate a liquid. The pressure generator changes a volume of the pressure chamber. The nozzle substrate is bonded to the first face of the liquid chamber substrate. The holding substrate has a third face bonded to the second face of the liquid chamber substrate, a fourth face opposite the third face, and second side faces respectively connected to the first side faces. The conductive resin covers the first side faces and the second side faces. The conductive frame is bonded to the fourth face of the holding substrate.

### Aspect 5

In the liquid discharge head according to any one of Aspects 1 to 4, a metal member is not exposed on the side faces of the liquid chamber substrate and the holding substrate.

In other words, the liquid chamber substrate and the holding substrate include silicon, and the first side faces of the liquid chamber substrate and the second side faces of the holding substrate are formed of the silicon.

### Aspect 6

The liquid discharge head according to any one of Aspects 1 to 5, further includes a metal base member and a metal cover member. The frame is attached to the base member without an insulator interposed therebetween. The cover member is bonded to the base member on the nozzle substrate side.

In other words, the liquid discharge head according to any one of Aspects 1 to 5, further includes a metal base made of metal and a metal cover made of metal. The conductive frame is directly attached and electrically connected to the metal base without an insulator interposed between the conductive frame and the metal base. The metal cover is bonded to a surface of the metal base adjacent to the nozzle substrate.

### Aspect 7

In the liquid discharge head according to any one of Aspects 1 to 6, the nozzle substrate, the liquid chamber substrate, and the holding substrate are made of silicon.

In other words, the nozzle substrate, the liquid chamber substrate, and the holding substrate include silicon.

### Aspect 8

A head module includes the liquid discharge head according to any one of Aspects 1 to 7.

In other words, a head module includes multiple liquid discharge heads including the liquid discharge head according to any one of Aspects 1 to 7 and a base holding the multiple liquid discharge heads.

### Aspect 9

A liquid discharge apparatus includes the head module according to Aspect 8.

In other words, a liquid discharge apparatus includes the head module according to Aspect 8, to discharge a liquid onto a medium and a conveyor to move the medium relative to the head module.

It should be noted that the present disclosure is not limited to the above-described embodiments. In the scope of the present disclosure, it is possible to modify, add, and convert each element of the above-described embodiments into contents that person skilled in the art can easily conceive. In addition, two or more of the embodiments and the applied cases described above can be appropriately combined.

As described above, according to one aspect of the present disclosure, a liquid discharge head can be provided that has a structure for discharging a current generated in a head substrate.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a liquid chamber substrate having:
a first face;
a second face opposite the first face;
four corner portions respectively having first edge portions on first side faces of the liquid chamber substrate; and
a pressure chamber to accommodate a liquid;
a pressure generator to change a volume of the pressure chamber;
a nozzle substrate bonded to the first face of the liquid chamber substrate; and
a holding substrate having:
a third face bonded to the second face of the liquid chamber substrate;
a fourth face opposite the third face; and
second edge portions on second side faces of the holding substrate, the second edge portions respectively connected to the first edge portions of the four corner portions;
a conductive resin covering:
the four corner portions; and
the first edge portions and the second edge portions from the first face of the liquid chamber substrate to the fourth face of the holding substrate; and
a conductive frame bonded to the fourth face of the holding substrate.

2. A liquid discharge head comprising:
a liquid chamber substrate having:
a first face;
a second face opposite the first face;
four corner portions respectively having first edge portions on first side faces of the liquid chamber substrate; and
a pressure chamber to accommodate a liquid;
a pressure generator to change a volume of the pressure chamber;
a nozzle substrate bonded to the first face of the liquid chamber substrate; and
a holding substrate having:
a third face bonded to the second face of the liquid chamber substrate;
a fourth face opposite the third face; and
second edge portions on second side faces of the holding substrate, the second edge portions respectively connected to the first edge portions of the four corner portions;
a conductive resin covering:
the four corner portions;
the first edge portions and the second edge portions from the first face of the liquid chamber substrate to the fourth face of the holding substrate; and
the first side faces; and
a conductive frame bonded to the fourth face of the holding substrate.

3. The liquid discharge head according to claim 1, further comprising an insulating resin:
between the conductive resin and the first edge portions; and
between the conductive resin and the second edge portions.

4. The liquid discharge head according to claim 2, further comprising an insulating resin:
between the conductive resin and the first side faces; and
between the conductive resin and the second edge portions.

5. A liquid discharge head comprising:
a liquid chamber substrate having:
a first face;
a second face opposite the first face;
first side faces on a periphery of the first face of the liquid chamber substrate; and
a pressure chamber to accommodate a liquid;
a pressure generator to change a volume of the pressure chamber;
a nozzle substrate bonded to the first face of the liquid chamber substrate; and
a holding substrate having:
a third face bonded to the second face of the liquid chamber substrate;
a fourth face opposite the third face; and
second side faces respectively connected to the first side faces;
a conductive resin covering the first side faces and the second side faces; and
a conductive frame bonded to the fourth face of the holding substrate.

6. The liquid discharge head according to claim 1,
wherein the liquid chamber substrate and the holding substrate include silicon, and
the first side faces of the liquid chamber substrate and the second side faces of the holding substrate are formed of the silicon.

7. The liquid discharge head according to claim 2,
wherein the liquid chamber substrate and the holding substrate include silicon, and
the first side faces of the liquid chamber substrate and the second side faces of the holding substrate are formed of the silicon.

8. The liquid discharge head according to claim 1, further comprising:
a metal base made of metal; and
a metal cover made of metal,
wherein the conductive frame is directly attached and electrically connected to the metal base without an insulator interposed between the conductive frame and the metal base, and
the metal cover is bonded to a surface of the metal base adjacent to the nozzle substrate.

9. The liquid discharge head according to claim 2, further comprising:
a metal base made of metal; and
a metal cover made of metal,
wherein the conductive frame is directly attached and electrically connected to the metal base without an insulator interposed between the conductive frame and the metal base, and
the metal cover is bonded to a surface of the metal base adjacent to the nozzle substrate.

10. The liquid discharge head according to claim 1,
wherein the nozzle substrate, the liquid chamber substrate, and the holding substrate include silicon.

11. A head module comprising:
multiple liquid discharge heads including the liquid discharge head according to claim 1; and
a base holding the multiple liquid discharge heads.

12. A liquid discharge apparatus comprising:
the head module according to claim 11, to discharge a liquid onto a medium; and
a conveyor to move the medium relative to the head module.
